(19) United States
(12) Patent Application Publication
(10) Pub. No.: US 2016/0098766 A1
(43) Pub. Date: Apr. 7, 2016

(54) FEEDBACK COLLECTING SYSTEM

(71) Applicants: Maqsood Alam, Murphy, TX (US); Muzammil Alam, Hyderabad (IN)

(72) Inventors: Maqsood Alam, Murphy, TX (US); Muzammil Alam, Hyderabad (IN)

(21) Appl. No.: 14/504,443

(22) Filed: Oct. 2, 2014

(51) Int. Cl. G06Q 30/02

(52) U.S. Cl. CPC G06Q 30/0282

(57) ABSTRACT

Exemplary embodiment of the present disclosure is directed towards a system for collecting feedback. The system includes a data collecting unit comprising an image capturing unit and acoustic transducer for collecting gesture, audio and video of the user respectively. The collected data is recognized and analyzed by the gesture recognition unit and audio/video recognition unit for providing feedback to the retailers. The system also includes a navigation unit to navigate the user based on the collected data to rate the respective retailer through a rating unit. Further the data of the users, predetermined actions to be performed for the provided gestures, audio and video and details of the one or more retailers are stored in a server.

### TECHNICAL FIELD

The present disclosure generally relates to the field of feedback collecting system. More particularly, the present disclosure relates to a feedback collecting system used to collect feedback through gestures and audio based input of the users.

### BACKGROUND

Conventionally, customer experience can be measured with greater accuracy by allowing customers to voice their opinions. Large volumes of customer feedback will ultimately allow to harness the secrets behind winning formulas. A study shows that there are two primary ways of ensuring higher number of response rates, either through incentivizing the customers for discounts on next purchases which may not be viable in most cases or by collecting feedback data at the point of experience by engaging the user and gathering feedback, all within seconds! It's also proven that incentivizing the customers may and garnering a large sample data may not give an accurate picture of feedback.

Also the customer experience is measured by requesting the real time user or virtual user to fill the feedback forms for the purchases made from the retail store through online/offline mode. The interested user provides his/her opinion by filing the feedback form. But this type of feedback is of no where useful, because the user is no way interested to spend their time for manually entering the feedback form. Furthermore, many online sites provide an option to rate the products/services through a rating star easily, but the rating provided by the respective user is unknown since the user is not interested to provide his/her personal details before or rating. So only the purchased customer details will be available with the retailer. Thus there is a no chance of having the details of the other normal user and allow to rate the product/service.

In the light of aforementioned discussion there exists a need of a feedback collecting system for collecting a gesture and audio based feedback.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

Exemplary embodiments of the present disclosure are directed towards system and method for collecting feedback.

An exemplary objective of the present disclosure is to collect feedback from users through a gesture, audio and video.

Another exemplary objective of the present disclosure to collect likes and dislikes of user by using thumbs up and thumbs down gesture.

Also another exemplary objective of the present disclosure is to recognize fingers of the hand opened in front of the feedback collecting system for collecting the feedback rated to the specific retailer.

Further another exemplary objective of the present disclosure is to enable the user to interact with the navigation screen using the hand and drag or select the required feedback for rating the retailer.

Still another exemplary objective of the present disclosure is to enable the user to select the audio feedback from the navigation interface to record the audio by an acoustic transducer included in the system and analyze by an audio/video recognition unit.

Yet another exemplary objective of the present disclosure is to convert the analyzed audio and video to text for rating the respective retailer.

According to a first aspect, the system includes a data collecting unit integrated with a user interface of one or more retailers configured to collect a gesture, audio and video provided by the one or more users to receive feedback from each individual user. The data collecting unit further includes a data capturing unit configured to capture image and video of one or more users and gesture provided by the one or more users to collect the feedback. The image and video captured by the one or more users stored in a data repository unit for analyzing the further visit of the one or more users and collect the feedback.

According to the first aspect, the system including a data collecting unit further includes an acoustic transducer to collect an audio provided by the one or more users for providing feedback to the one or more retailers.

According to the first aspect, the system includes a gesture recognition unit configured to recognize a gesture collected by the data collecting unit and analyze the captured gesture to perform a respective predetermined action.

According to the first aspect, the system includes an audio/video recognition unit configured to recognize an audio and video collected by the data collecting unit and analyze the collected audio and video to provide rating for the respective retailer.

According to the first aspect, the system includes a navigation unit configured to navigate the one or more users based on the gestures, audio and video collected from the one or more users for providing feedback for the one or more retailers.

According to the first aspect, the system includes a rating unit configured to rate the one or more retailers selected by the one or more users based on the gestures, audio and video received from a specified user.

According to the first aspect, the system includes a server configured to store the data of the one or more users, predetermined actions to be performed for the provided gestures, audio and video and details of the one or more retailers.

According to a second aspect, a method for enabling users to provide feedback is disclosed. According to the second aspect, the method includes collecting a gesture, an audio and a video provided by the one or more users by a data collecting unit integrated with a user interface of one or more retailers to receive data from each individual user. The data collecting unit captures an image and video of one or more users and a gesture provided by the one or more users by a data capturing unit to collect the feedback. The image and video captured by the one or more users stored in a data repository unit for analyzing the further visit of the one or more users and for collecting the feedback.

According to the second aspect, the method includes collecting an audio provided by the one or more users by an acoustic transducer for providing feedback to the one or more retailers.

According to the second aspect, the method includes recognizing a gesture collected by the data collecting unit by a gesture recognition unit and analyzing the collected gesture to perform a respective predetermined action.

According to the second aspect, the method includes recognizing an audio and video collected by the data collecting unit by an audio/video recognition unit and analyzing the collected audio and video to provide rating for the respective retailer.

According to the second aspect, the method includes navigating the respective one or more users based on the gestures, audio and video collected from the one or more users by a navigation unit for providing feedback for the one or more retailers.

According to the second aspect, the method includes rating the one or more retailers selected by the one or more users based on the gestures, audio and video received from a specified user by a rating unit.

According to the second aspect, the method includes storing the data of the one or more users, predetermined actions to be performed for the provided gestures, audio and video and details of the one or more retailers in a server.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1A-1D depict a feedback collecting system, according to an exemplary embodiment of the present disclosure.

FIG. 2 is a block diagram depicting a communication established between feedback collecting system and server, according to an exemplary embodiment of the present disclosure.

FIG. 3 is a flow diagram depicting a feedback collecting system, according to an exemplary embodiment of the present disclosure.

FIG. 4 is a flow diagram depicting a gesture based feedback collecting system, according to an exemplary embodiment of the present disclosure.

FIG. 5 is a flow diagram depicting an audio based feedback collecting system, according to an exemplary embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

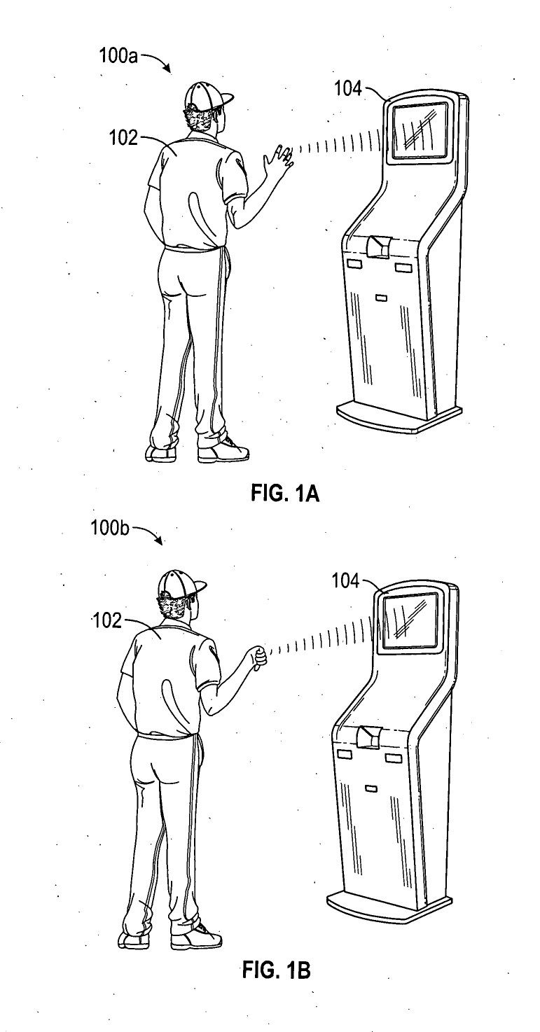

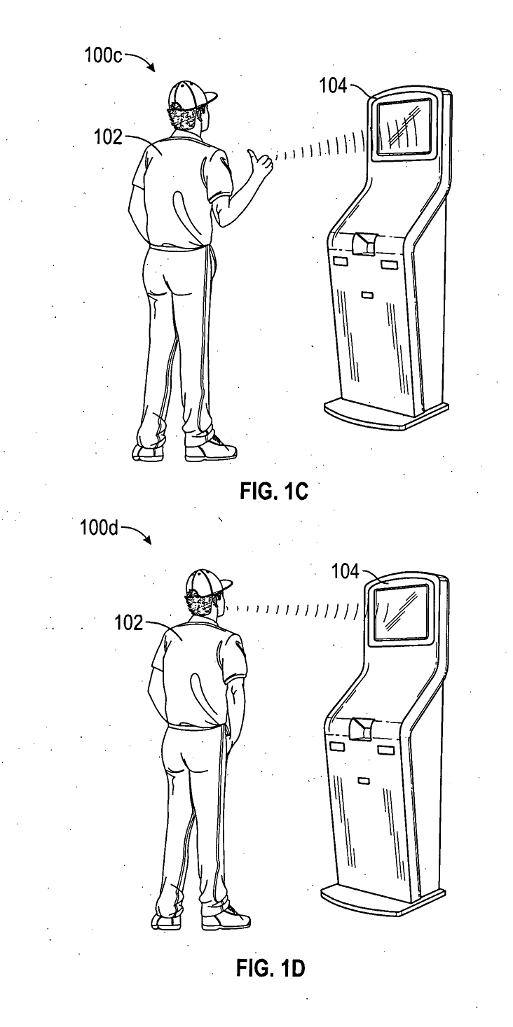

FIG. 1A is a diagram 100a depicting a feedback collecting system. According to a non limiting exemplary embodiment of the present disclosure, the feedback collecting system 104 is an electronic kiosk integrated with a data collecting unit comprising a data capturing unit. The electronic kiosk positioned at any retail market and/or any service provider center and the like and includes a computer terminal used for providing feedback using gesture collected by a user 102.

As shown in FIG. 1A, the user 102 visiting a retailer is requested to provide a feedback for the purchases and/or services received by rating the respective retailer with a specified score by assessing the quality of service provided by the retailer. Thus to provide a feedback, the user 102 interacts with a user interface of the feedback collecting system 104 and navigates the interface through hand. The movement of the hand is captured by the data capturing unit included in the feedback collecting system 104 and recognizes the movement and navigates the user to the respective hypertext document for rating the retailer. Then the user is enabled to drag and/or select the required feedback for rating the retailer. For example, the user may drag and drop the stars from a bucket or drag from star 1 to star 5 to rate the retailer. Also the user may provide rating to the retailer by using the fingers of the palm through the data capturing unit used to capture image of the user's palm.

Also as shown in FIG. 1A, the image of the user 102 is captured and uploaded in a data repository unit of the feedback control system 104 to analyze the further visit of the user 102 and/or if the user 102 is having a different rating on further visit. The image captured by the image capturing unit included in the feedback control system′ 104 is analyzed and correlated with the previous data stored in the data repository unit. Also along with the image of the user 102, the demographics such as time stamp, age, gender, and the like of the user are also collected by the image capturing unit and stored in the data repository unit for further analyzing the access time of the specified user with a stored identification provided to each individual retailer.

Further, the feedback received from the user 102 is transmitted to the retailer in real time along with the time, age and gender collected from the user 102 and stored in the data repository unit for providing alerts to the retailer through a short message service and/or an email.

FIG. 1B is a diagram 100b depicting a feedback collecting system accessed through a finger recognition of a gesture. According to a non limiting exemplary embodiment of the present disclosure, the feedback collecting system 104 including a data capturing unit captures the finger gestures provided by the user 102.

As shown in FIG. 1B, the user interacting with the user interface of the feedback collecting system 104 provides a feedback using thumbs down gestures through a data capturing unit included in the data collecting unit. The captured gesture is recognized and analyzed to provide dislikes to the retailer and the number of dislikes gained by the retailer is dynamically updated.

FIG. 1C is a diagram 100c depicting a feedback collecting system accessed through a gesture used to analyze likes and dislikes of the user. According to a non limiting exemplary embodiment of the present disclosure, the feedback collecting system 104 including a data capturing unit captures the finger gestures provided by the user 102.

As shown in FIG. 1C, the user interacting with the user interface of the feedback collecting system 104 provides a feedback using thumbs up gestures through a data capturing unit included in the data collecting unit. The respective gesture captured is recognized and analyzed to provide likes to the retailer and the number of likes gained by the retailer is dynamically updated.

FIG. 1D is a diagram 100d depicting a feedback collecting system accessed through an audio collected from a user. According to a non limiting exemplary embodiment of the present disclosure, the feedback collecting system 104 is an electronic kiosk integrated with a data collecting unit comprising an audio/video recognition unit. The feedback collecting system 104 is used to provide feedback through voice of the user 102.

As shown in FIG. 1D, the user 102 visiting a retailer is requested to provide a feedback for the purchases and/or services received by the user 102 by rating the respective retailer with a specified score on assessing the quality of service provided by the retailer. The user 102 interacts with a feedback collecting system 104 by transmitting a voice along with the video for providing feedback to the respective retailer. The voice enabled by the user 102 is received by the acoustic transducer included in the data collecting unit integrated with the feedback collecting system 104. The information to the voice collected by the acoustic transducer along with the video captured by the data capturing unit is recognized by the audio/video recognition unit to fetch the data conveyed by the user 102 to rate the retailer.

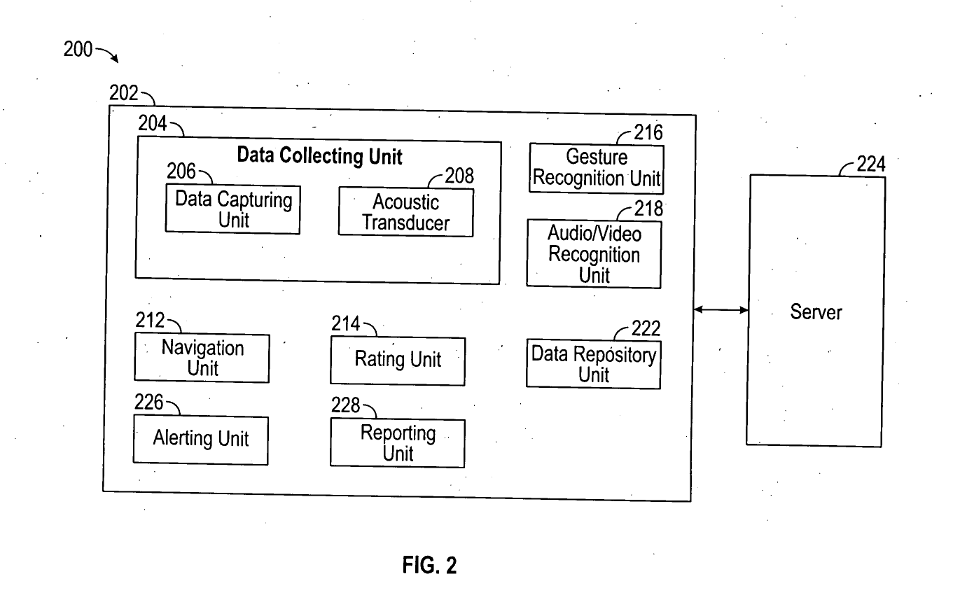

FIG. 2 is a block diagram 200 depicting a communication established between feedback collecting system and server. According to a non limiting exemplary embodiment of the present disclosure, the feedback collecting system 202 is used to collect the feedback from the users visiting retailer. In some embodiments, the feedback collecting system 202 can be an individually operated system used to provide feedback for predetermined retailers. In some embodiments, the feedback collecting system 202 can be integrated in an in-built feedback system provided at each individual retailer to provide feedback for the respective retailer. As shown in FIG. 2, the feedback collecting system 202 includes a data collecting unit 204 configured to collect the feedback data provided by the user, which may be gesture data and/or voice data. The data collecting unit 204 includes a data capturing unit 206 to capture the gesture image and an acoustic transducer 208 to collect the audio of the user.

As shown in FIG. 2, the data capturing unit 206 configured to capture image and/or video of the user to provide feedback and store the captured image and/or video in a data repository unit 222. Also the data capturing unit 206 configured to capture gesture image of a user for providing a feedback to the retailer. The captured gesture image is processed and analyzed by the gesture recognition unit 216 to identify the type of gesture provided by the user for rating the retailer and the provided gesture is also stored in the data repository unit 222 along with the time stamp, age, gender and store ID to further analyze the access of the user. Also the feedback collecting system 202 is activated by the gesture provided by the user. The gesture based feedback provided by the user can be of three types such as simple like and dislike feedback, hand finger recognition and hand based navigation. The simple like and dislike feedback is used to convey like and dislike of the user by recognizing the thumbs up and thumbs down gesture collected from the user. For example, if the user provides a thumb up gesture it is recognized as the user likes the specific retailer and if the user provides a thumb down gesture it is recognized as the user dislikes the specific retailer.

Also as shown in FIG. 2, the other gesture based feedback is a hand finger recognition, wherein the fingers open in the full palm is recognized as the number of count as feedback provided to the retailer. For example, in the full palm if the user opens the complete 5 fingers, then 5 star rating is recognized for the specific retailer. Further the other gesture based feedback is a hand based navigation, where the user can interact with the screen using hand and drag or selects the required feedback. For example, if the user is interested to provide a 5 star feedback to the retailer, then the user may drag and drop the stars from a bucket and/or drag the cursor/icon from start 1 to star 5. Also, the acoustic transducer 208 configured to collect audio of the user to provide feedback for the retailer. The audio collected by the acoustic transducer 208 is analyzed along with the video captured by the data capturing unit 204 and recognized by the audio/video recognition unit 218 to identify the type of audio and video collected from the user for rating the retailer. For example, the user interacting with the feedback collecting system establishes a communication by providing an audio signal. The audio signal provided by the user is collected by an acoustic transducer 208 to select an option provided over the navigation interface of the feedback collecting system. The respective hypertext document selected by the user is rated by recognizing the audio provided by the user through an audio/video recognition unit 218.

Further as shown in FIG. 2, the feedback collecting system also includes a navigation unit 212 configured for allowing the user to navigate to the respective hypertext document of the retailer to provide a feedback to the retailer through a gesture recognized by the gesture recognition unit and an audio recognized by the audio/video recognition unit 218. The feedback collecting system 202 also includes a rating unit 214 to rate the each individual retailer through a gesture and audio. Also further the data provided by the user is stored in a data repository unit and transmitted to a server 224 in communication with the feedback collecting system 202. The data uploaded in server 224 is used for the access of the retailer for analyzing the visit of the user and the feedback provided by the user. Further the rating collected from the user is transmitted to the retailer in real time through an alert by a short message service or an electronic mail for every predetermined period of time along with the time stamp, age, gender and store id to analyze the user and the access time. Also the retailer receives integration points related to the customer relationship and attendance to the staff and/or dealers available with the retail store. Also further an alerting unit 226 included in the data collecting unit 204 transmits alerts related to the feedback collected to the respective retailers and a reporting unit 228 configured to provide an analysis report of the feedback to the retailers.

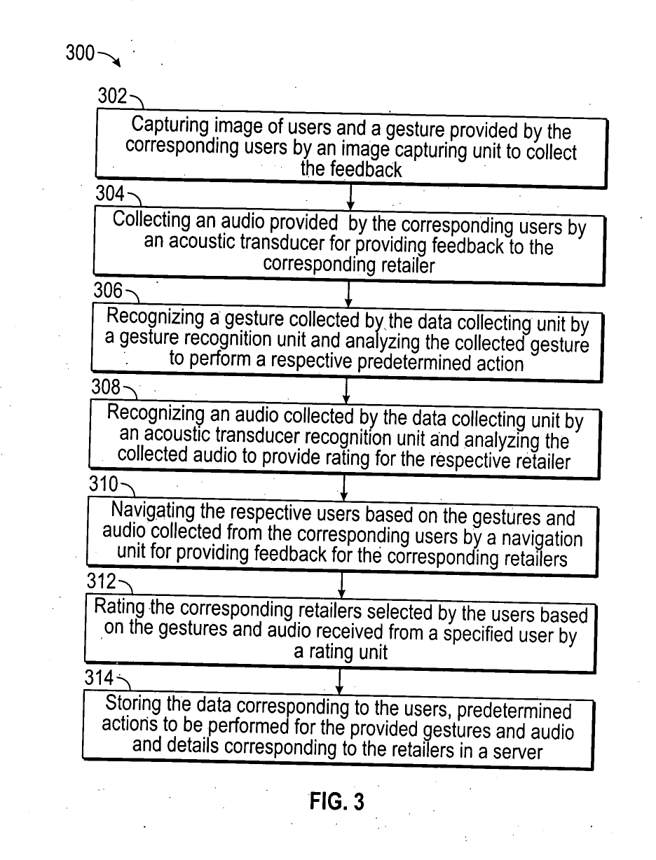

FIG. 3 is a flow chart 300 depicting a feedback collecting system. According to a non limiting exemplary embodiment of the present disclosure, the method for collecting feedback starts at step 302 by capturing image and video of users and a gesture of the corresponding users by a data capturing unit included in the data collecting unit to collect the feedback and store the captured image in a data repository unit for analyzing the further visit of the user. Next at step 304, an audio provided by the users is collected by an acoustic transducer included in the data collecting unit for providing feedback to the corresponding retailer.

As shown in FIG. 3, the gestures captured by the data capturing unit at step 302 are recognized by a gesture recognition unit at step 306 and analyzed to perform a respective predetermined action. Next at step 308, the audio collected by the acoustic transducer at step 304 is recognized by an audio/video recognition unit and analyzed to provide rating for the respective retailer. Also at step 310 the gestures, audio and video collected from the users are used to navigate the users through a navigation unit for providing feedback for the respective retailer and the navigated user is enabled to provide rating through the gestures, audio and video by using a rating unit at step 312. Thus at last, at step 314 the data corresponding to the users, predetermined actions to be performed for the gestures, audio and video and also the data corresponding to the retailers are stored in a data repository unit.

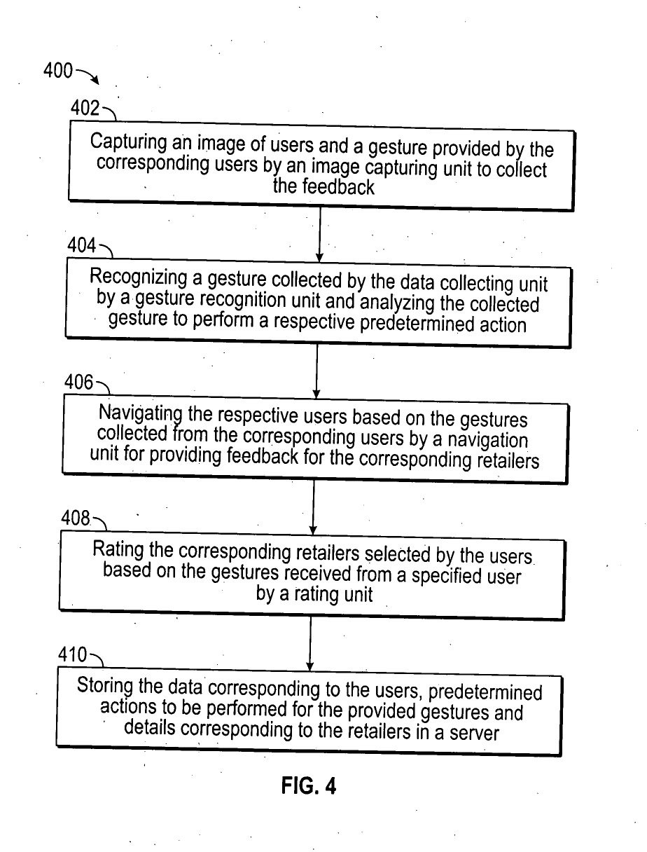

FIG. 4 is a flow diagram 400 depicting a gesture based feedback collecting system. According to a non limiting exemplary embodiment of the present disclosure, the method of collecting feedback through gestures starts at 402 by capturing an image and video of users and a gesture provided′ by the users by a data capturing unit to collect the feedback and store the captured image and video in a data repository unit for analyzing the further visit, of the user. Next at 404, the gesture collected by the data collecting unit is recognized by a gesture recognition unit and analyzed to perform a respective predetermined action.

As shown in FIG. 4, at step 406 the gestures collected from the respective users are used to navigate the users to provide feedback for the retailer. Next at step 408, the user is enabled to rate the retailer by a rating unit based on the gestures collected from the user. Further at step 410, the data corresponding to the users, predetermined action to be performed for the gestures and also the data corresponding to the retailers are stored in a data repository unit.

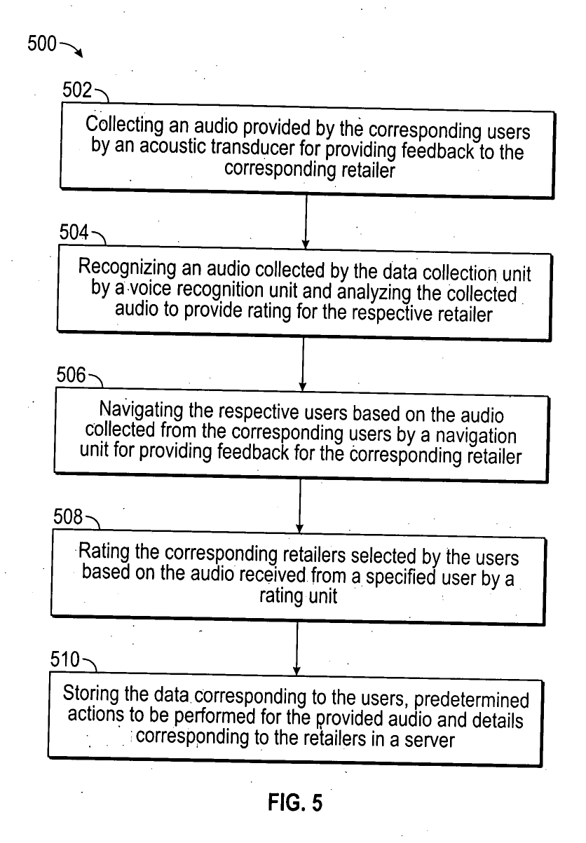

FIG. 5 is a flow diagram 500 depicting an audio based feedback collecting system. According to a non limiting exemplary embodiment of the present disclosure, the method of collecting feedback through audio starts at step 502 by collecting an audio provided by the users by an acoustic transducer included in the data collecting unit to collect the feedback. Next at step 504, the audio collected by the data collecting unit is recognized and analyzed by an audio/video recognition unit to provide rating for the respective retailer.

As shown in FIG. 5, at step 506 the audio collected from the users is used to navigate the respective user to provide feedback for the retailer. Next at step 508, the user is enabled to rate the retailer by a rating unit based on the audio collected from the users. Further at step 510, the data corresponding to the users, predetermined action to be performed for the collected audio and also the data corresponding to the retailers are stored in a data repository unit.

Although the present invention has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present invention is defined by the appended claims and includes both combinations and sub combinations of the various features described herein above as well as variations and modifications thereof, which would occur to persons skilled in the art upon reading the foregoing description.

What is claimed is:

1. A system for collecting feedback, the system comprising:
a data collecting unit displaying a user interface of one or more retailers configured to collect a gesture; audio; and video provided by the one or more users to receive feedback from the each individual user, whereby the data collecting unit comprising:
a data capturing unit configured to capture at least one of image; and video of one or more users; and gesture provided by the one or more users to collect the feedback, whereby the at least one of image; and video captured by the one or more users stored in a data repository unit for analyzing the further visit of the one or more users to collect the feedback;
an acoustic transducer configured to collect an audio provided by the one or more users for providing feedback to the one or more retailers;
a gesture recognition unit recognizes a gesture collected by the data collecting unit and analyzes the captured gesture to perform a respective predetermined action;
an audio and video recognition unit recognizes an audio; and video collected by the data collecting unit and analyzes the collected audio; and video to provide rating for the respective retailer;
a navigation unit configured to navigate the each individual user based on the gestures; and audio collected from the one or more users for providing feedback for the one or more retailers;
a rating unit configured to rate the one or more retailers selected by the one or more users based on the gestures; audio; and video received from each individual user; and
a server configured to store the data of the one or more users; predetermined actions to be performed for the provided gestures; and audio; and video; and details of the one or more retailers.

2. The system of claim 1, wherein time stamp of the captured image; and video to be recorded; and uploaded in the data repository unit to analyze the assessment of each individual user.

3. The system of claim 1, wherein age; and gender of the one or more users also collected and stored in the data repository unit for identifying the access of the respective user.

4. The system of claim 1, wherein the feedback provided by each individual user through gestures; and audio; and video stored in the data repository unit.

5. The system of claim 1, wherein the one or more retailers provided with a unique identification for analyzing the assessment of each individual user with the specific retailer.

6. The system of claim 1, wherein an alert unit configured to transmit alerts to the one or more retailers related to the feedback provided by each individual user.

7. The system of claim 1, wherein a reporting unit provides a report to the analysis of the rating provided for the specific retailer.

8. The system of claim 1, wherein the gesture; and audio collected from the one or more users configured to activate the user interface of the one or more retailers for providing feedback.

9. The system of claim 1, wherein the one or more retailers configured to receive a real time analytics for the feedback collected from each individual user along with the time; store ID; and gender.

10. The system of claim 1, wherein the one or more retailers receive alerts through a short message service; and electronic mail based on the predetermined threshold level set by the one or more retailers.

11. The system of claim 1, wherein the one or more retailers receive integration points related to customer relationship; and staff attendance.

12. A method comprising:
collecting a gesture; an audio; and video provided by the one or more users by a data collecting unit integrated with a user interface of one or more retailers to receive data from the one or more users, whereby the data collecting unit comprising
capturing an image; and video of one or more users; and a gesture provided by the one or more users by a data capturing unit to collect the feedback, whereby the image; and video captured of the one or more users stored in a data repository unit for analyzing the further visit of the one or more users for collecting the feedback;
collecting an audio provided by the one or more users by an acoustic transducer for providing feedback to the one or more retailers;
recognizing a gesture collected by the data collecting unit by a gesture recognition unit; and analyzing the collected gesture to perform a respective predetermined action;
recognizing an audio; and video collected by the data collecting unit by an audio; and video recognition unit; and analyzing the collected audio; and video to provide rating for the respective retailer;
navigating the one or more users based on the gestures; and audio collected from the one or more users by a navigation unit for providing feedback for the one or more retailers;
rating the one or more retailers selected by the one or more users based on the gestures; and audio; and video received from a specified user by a rating unit; and
storing the data corresponding to the one or more users; predetermined actions to be performed for the provided gestures; and audio; and video; and details to the one or more retailers in a server.
